(19) United States
(12) Patent Application Publication
(10) Pub. No.: US 2026/0148203 A1
(43) Pub. Date: May 28, 2026

(54) INTELLIGENT RECYCLING SYSTEM WITH AUTOMATED MATERIAL PROCESSING AND REWARD DISTRIBUTION

(71) Applicant: Ben Kaviani, Los Angeles, CA (US)

(72) Inventor: Ben Kaviani, Los Angeles, CA (US)

(21) Appl. No.: 18/957,755

(22) Filed: Nov. 23, 2024

(51) Int. Cl. G06Q 10/30; G06F 21/40; G06Q 10/047; G06Q 10/087; H04L 9/00

(52) U.S. Cl. CPC G06Q 10/30; G06F 21/40; G06Q 10/047; G06Q 10/087; H04L 9/50

(57) ABSTRACT

An intelligent recycling system providing automated material processing through a network of integrated kiosks. Each kiosk incorporates solar power systems, multi-spectral scanning arrays, and automated sorting mechanisms for reliable material identification and segregation. The system implements secure material tracking through RFID technology and distributed ledger protocols, enabling automated chain-of-custody management. A central management platform coordinates operations using artificial intelligence for predictive analytics and route optimization. The system features environmental controls, modular design, and a multi-tier reward distribution mechanism, enabling adaptive deployment across diverse locations while incentivizing recycling participation. Automated material handling and intelligent sorting optimize resource recovery and operational efficiency through real-time monitoring and predictive maintenance.

### CROSS-REFERENCE TO RELATED APPLICATIONS

The present application relates to recycling systems and methods, specifically focusing on automated waste management, material sorting, and incentivized recycling. This application is a continuation-in-part of and claims the benefit of U.S. Patent Application No. 63/603,152, filed Nov. 28, 2023, entitled “SMART ENVIRONMENTAL BOX SYSTEM FOR RECYCLABLE GOODS”, which is hereby incorporated by reference in its entirety.

This application is also related to and incorporates by reference the following prior art:
U.S. Patent Application Publication No. US 2016/0200507 A1, published Jul. 14, 2016, entitled “Extensible Recycling System”;
U.S. Patent Application Publication No. US 2022/0005002 A1, published Jan. 6, 2022, entitled “Closed Loop Recycling Process and System”;
U.S. Patent Application Publication No. US 2009/0188841 A1, published Jul. 30, 2009, entitled “Automatic Materials Sorting Device”;
U.S. Patent Application Publication No. US 2021/0295039 A1, published Sep. 23, 2021, entitled “Methods and Electronic Devices for Automated Waste Management”; and
U.S. Patent Application Publication No. US 2008/0041996 A1, published Feb. 21, 2008, entitled “Methods and Apparatus for Processing Recyclable Containers.”

The disclosures of each of the above-referenced applications are hereby incorporated by reference in their entireties.

### FEDERALLY SPONSORED RESEARCH

Not Applicable

### SEQUENCE LISTING

Not Applicable

### BACKGROUND OF THE INVENTION

### Field of the Invention

The present invention relates to automated waste management systems, specifically to intelligent recycling systems integrating material identification technology, automated sorting mechanisms, distributed ledger systems, and advanced analytics for optimizing recycling operations and incentivizing participation.

### Description of Related Art

The recycling industry faces critical technical challenges in material identification, sorting efficiency, and process automation, resulting in substantial economic and environmental impact. Current industry data indicates contamination rates exceeding 25% and global material recovery rates below 30%, representing an annual economic loss of $200 billion globally while contributing significantly to environmental degradation through inappropriate waste disposal.

Conventional recycling centers employ automation technologies with the following documented limitations:
1. Material Identification Systems
   Near-infrared (NIR) optical sorters: 85-90% accuracy limited to clean, single-material items
   Magnetic separators: 95% efficiency for ferrous metals only
   Eddy current separators: 90% efficiency for non-ferrous metals
   Combined system accuracy dropping to 60% with mixed or contaminated materials
2. Process Integration and Data Management
   Fragmented data collection across collection points
   Manual reconciliation requirements increasing error rates by 15-20%
   Lack of real-time material tracking and chain-of-custody verification
   Absence of predictive analytics for maintenance and optimization
   Limited integration between collection, sorting, and processing phases
3. Technical System Constraints
   Fixed sorting parameters requiring manual adjustments
   Processing speed limitations of 1 metric ton per hour
   Energy inefficiency in traditional sorting mechanisms
   Limited adaptability to new material compositions
   Inability to authenticate material quality at collection points

Prior art attempts to address these limitations demonstrate significant gaps. U.S. Patent No. 20160200507 A1 implements basic optical sorting but achieves only 80% accuracy with clean materials and lacks adaptive learning capabilities. U.S. Patent No. 20220005002 A1 introduces distributed ledger technology but maintains traditional mechanical sorting, failing to address fundamental material identification and processing challenges.

The current technical limitations create cascading effects throughout the recycling value chain:
1. Operational Impact
   20% cross-contamination rates reducing material value by 40-60%
   30% increase in processing costs from manual intervention
   25% reduction in throughput from system inefficiencies
   45% of potentially recyclable materials diverted to landfills
2. Data Analytics Deficiencies
   Inability to optimize collection routes in real-time
   Limited predictive maintenance capabilities increasing downtime by 30%
   Absence of material flow optimization reducing system efficiency by 25%
   Lack of integrated performance metrics for system optimization
3. Economic Framework Limitations
   Disconnected incentive mechanisms reducing participation rates
   Manual verification processes increasing operational costs by 35%
   Inefficient resource allocation from limited data visibility
   Inability to validate material quality impacting market value

These technical deficiencies establish a clear need for an integrated system that addresses:
Advanced material identification with adaptive learning capabilities
Real-time tracking and verification systems
Energy-efficient automated sorting
Comprehensive data analytics for system optimization
Integrated incentive mechanisms for participant engagement

The present invention provides a comprehensive solution through an intelligent ecosystem that combines advanced sensing technology, artificial intelligence, distributed ledger systems, and real-time analytics. This integration enables:
95% material identification accuracy
40% reduction in processing costs
60% improvement in sorting efficiency
Real-time optimization of collection and processing operations
Transparent and automated incentive distribution

The system's ability to generate and analyze comprehensive operational data represents a paradigm shift in recycling management, enabling continuous optimization and adaptation to changing material streams while creating a sustainable economic model for all stakeholders.

### BRIEF SUMMARY OF THE INVENTION

The present invention provides an intelligent recycling ecosystem comprising networked kiosks that automate material identification, sorting, and reward distribution through integrated artificial intelligence and distributed ledger technology.

### Technical Advantages of the Invention

The present invention provides several technical advantages over prior art systems:

### 1. Enhanced Material Recognition:

Multi-spectral fusion achieving 95% accuracy
Real-time processing under 100 ms
Adaptive learning capabilities

### 2. Improved Processing Efficiency:

Edge computing reducing latency by 60%
Distributed processing architecture
Automated sorting optimization

### 3. Advanced Security Implementation:

Hardware-based encryption
Multi-factor authentication
Blockchain validation

### 4. System Integration Benefits:

Reduced error rates from 25% to <2%
Energy efficiency improvement of 40%
Processing speed increase of 300%

### 5. Comprehensive Error Management:

Automated fault detection
Real-time error correction
Redundant system failover
Data integrity verification
Recovery protocol implementation

In one aspect, the invention provides a smart recycling system comprising:
A network of modular kiosks powered by solar energy, with battery storage and optional grid connectivity,
Each kiosk incorporating multi-spectral cameras and sensor arrays for material identification,
An artificial intelligence processing unit for real-time material classification and an automated sorting mechanism directing materials into segregated compartments,
A blockchain-based transaction recording system and an RFID tracking system for secure material chain-of-custody,
An interactive user interface enabling user authentication and reward selection.

In another aspect, the invention provides a method for automated waste management, comprising:
Authenticating users through a multi-factor verification system,
Receiving recyclable materials through a secure input mechanism,
Analyzing materials using multi-spectral scanning technology,
Classifying materials via artificial intelligence processing,
Sorting materials automatically into designated compartments,
Recording transactions on a distributed ledger, and
Distributing rewards based on material type and quality.

In a further aspect, the invention provides a centralized management platform that:
Processes real-time operational data for system optimization,
Implements predictive analytics for route planning and maintenance,
Manages reward distribution across multiple channels, and
Generates comprehensive performance and environmental impact reports, while maintaining secure material tracking through processing centers.

The system's reward structure includes options for:
Digital tokens for immediate redemption,
Retail discounts from participating merchants,
Eco-credit card benefits with enhanced cashback options,
Charitable donation capabilities, and
Recycled-content product incentives.

The invention achieves several technical objectives:
Enhanced material processing through precise identification and sorting,
Optimized operations through predictive analytics and route planning,
Secure transaction recording and reward distribution,
Comprehensive system monitoring and reporting, and
Integrated environmental impact assessment.

Through this combination of technologies, the invention establishes an efficient and sustainable recycling ecosystem adaptable for diverse environments, from retail locations to indoor facilities.

The details of one or more implementations of the invention are set forth in the accompanying drawings and description below. Other aspects, features, and advantages of the invention will be apparent from the description, drawings, and claims.

### DRAWING BRIEF DESCRIPTION

FIG. 1 is a block diagram illustrating the system architecture of a smart recycling ecosystem. The diagram shows the interaction between the management platform comprising AI system, blockchain, and analytics modules; the network of MagicBoxIn kiosks; logistics operations; and processing centers. Arrows indicate data flow and operational relationships between components.

FIG. 2 is a front elevation view and partial cutaway of the MagicBoxIn kiosk structure. The diagram shows the external configuration including solar panels, user interface screen, and material input slot, along with an internal view revealing the multi-spectral scanning system, automated sorting mechanisms, and modular storage compartments for different materials.

FIG. 3 is a flowchart depicting the material processing and reward distribution sequence. The diagram illustrates the progression from material input through multi-spectral scanning, AI analysis, and sorting, while showing the parallel reward process including options for donations, retail coupons, blockchain tokens, and green card benefits. The flow continues through RFID tagging and storage.

FIG. 4 is a sequence diagram showing the user interaction process with the MagicBoxIn system. The diagram demonstrates the step-by-step flow from user authentication through material deposit, verification, reward selection, and reward distribution, including blockchain transaction recording and reward system integration.

FIG. 5 is a schematic diagram illustrating the network and security architecture of the system. The diagram shows the hierarchical structure from kiosk-level operations through edge computing to cloud platform, including data synchronization protocols, security measures, and management interface integration.

FIG. 6 is a flowchart showing the processing center operations and logistics workflow. The diagram illustrates how materials are collected from kiosks, processed at distribution centers, tracked via RFID, and distributed through various channels, with blockchain validation at key points.

### DETAILED DESCRIPTION OF THE PREFERRED EMBODIMENTS

### Definitions Section

As used throughout this specification and claims, the following terms shall have the specific meanings defined herein, unless context clearly indicates otherwise:

In the following detailed description, numerous specific details are set forth to provide a thorough understanding of the claimed subject matter. For purposes of explanation, specific configurations, parameters, and implementation details are set forth to provide a thorough understanding of the present invention. However, it will be apparent to one skilled in the art that the present invention may be practiced without these specific details. Furthermore, well-known features may be omitted or simplified to avoid obscuring the present invention.

Throughout this specification, the following terms shall have the following meanings:

### Material Identification Parameters:

“Multi-spectral scanning” refers to simultaneous material analysis using multiple wavelength ranges, specifically:
   “Visible spectrum” means electromagnetic radiation in the range of 400-700 nanometers (nm)
   “Near-infrared spectrum” means electromagnetic radiation in the range of 701-2500 nm
   “Spectral signature matching” refers to the comparison of measured spectral data against a reference database containing at least 1000 known material signatures
“Material classification confidence” is calculated through:
   Primary spectral analysis (minimum 90% confidence)
   Secondary characteristic verification (minimum 90% confidence)
   Tertiary physical property validation (minimum 90% confidence)
   Combined assessment requiring minimum 95% aggregate confidence

### Processing Performance Metrics:

“Edge computing capabilities” refers to local processing power of minimum 4 TOPS (Tera Operations Per Second) with 8GB minimum cache memory
“Sub-second classification latency” means processing and classification time under 1000 milliseconds from material detection to identification
“Real-time processing” refers to operations completed within 100 milliseconds of input
“Classification accuracy” is measured as the percentage of correct material identifications verified against known reference samples over a minimum of 10,000 test cases

### Hardware Specifications:

“Solar-powered energy system” comprises photovoltaic arrays generating minimum 2 kW power with battery backup providing 24-hour autonomous operation
“Energy conversion efficiency” is calculated as the ratio of usable output power to input power, expressed as a percentage
“UHF RFID” refers to radio-frequency identification operating in the 860-960 MHz frequency range
“Fill-level accuracy” is measured using capacitive sensors with calibrated reference measurements over minimum 1,000 sample points

### Authentication Parameters:

“Multi-factor authentication” requires at least three distinct verification methods from:
   Biometric scanning at minimum 1000 dpi resolution
   RFID reading at 13.56 MHz with −60 dBm sensitivity
   Encrypted PIN verification
   NFC detection at 13.56 MHZ
   QR code scanning at 1280×960 resolution

### System Performance Metrics:

“Material sorting accuracy” is measured as percentage of correctly sorted items verified through multi-point checking over minimum 10,000 sorting operations
“Read accuracy” for RFID systems is calculated over minimum 100,000 read attempts under varying environmental conditions
“Chain-of-custody accuracy” refers to successful tracking of materials through all system checkpoints with timestamp and location verification

### Environmental Control Parameters:

“Temperature control” maintains environment within ±0.5° C. of setpoint
“Humidity control” maintains relative humidity within ±2% RH of setpoint
“Environmental monitoring” includes continuous measurement and logging of temperature, humidity, and air quality at minimum 1-minute intervals

### Network and Security Parameters:

“Secure communication” implements TLS 1.3 encryption protocols with hardware-based cryptographic modules
“Blockchain consensus” refers to Proof-of-Stake validation requiring minimum 2-second confirmation time
“Smart contract execution” means automated processing of predefined conditions with immutable recording on distributed ledger

### Reward System Parameters:

“Dynamic market value” refers to real-time price adjustments updated at minimum 5-minute intervals
“Reward calculation” includes material quality assessment, market value, and sustainability multipliers (1.1-2.0×)
“Transaction validation” requires consensus confirmation from minimum 51% of network nodes

### System Accuracy Calculations:

All percentage-based accuracy metrics are calculated using the formula:
Accuracy=(Correct Operations/Total Operations)×100
measured over minimum sample size of 10,000 operations unless otherwise specified
All measurements include standard deviation and confidence intervals at 95% confidence level
All tolerances are specified as ±values representing maximum allowable deviation from stated nominal values
   “Confidence metrics” means statistical measures of classification certainty calculated as:
Primary confidence score (0-100%)
Secondary verification score (0-100%)
Combined weighted average with minimum 95% threshold for acceptance
   “Federated learning” means distributed machine learning process wherein:
Local models train on kiosk-specific data
Model updates aggregate at central server
Updated models redistribute to network nodes
Training occurs without raw data transfer

These definitions apply throughout the claims and specification unless explicitly stated otherwise. Where a term is used without specific definition, it shall take its ordinary meaning as understood by one skilled in the art at the time of the invention.

In the following detailed description, numerous specific details are set forth to provide a thorough understanding of the claimed subject matter. However, it will be understood by those skilled in the art that claimed subject matter may be practiced without these specific details. In other instances, methods, procedures, components, and/or circuits have not been described in detail to avoid obscuring the claimed subject matter.

The present invention provides a smart environmental box system, hereinafter referred to as the “system,” which integrates artificial intelligence (AI), multi-spectral material analysis, automated sorting mechanisms, and distributed ledger technology into a unified recycling ecosystem. In various embodiments described herein, the system operates through a network of interconnected kiosks that communicate with a central management platform while maintaining independent operational capability through edge computing and local data processing.

In accordance with one aspect of the present invention, each kiosk within the system network comprises a solar-powered unit with integrated battery storage, wherein said unit incorporates a secure material input mechanism, multi-spectral scanning apparatus, artificial intelligence processing capabilities, automated sorting mechanisms, and modular storage compartments. The kiosks are configured to operate both independently and as networked nodes within the larger ecosystem, maintaining full functionality during both connected and disconnected states.

The artificial intelligence system processes data streams from multiple sensor arrays, including:
a) multi-spectral camera inputs for real-time material classification;
b) weight sensor data for mass verification;
c) environmental sensor readings for operational optimization; and
d) capacity sensor information for storage management.

Said artificial intelligence system achieving accuracy exceeding 95% via continuous learning and real-time adaptation to environmental conditions.

In one embodiment, the system implements a multi-tiered architecture comprising:
a) a physical layer including:
   secure material input mechanisms
   multi-spectral sensor arrays
   automated sorting apparatus
   modular storage systems with RFID tracking;
b) a processing layer incorporating:
   edge computing processors
   artificial intelligence analysis engines
   local data management systems
   predictive maintenance algorithms;
c) a network layer facilitating:
   encrypted communication protocols
   blockchain data synchronization
   remote system monitoring
   secure API interfaces;
d) an application layer managing:
   multi-factor user authentication
   customizable reward distribution
   transaction processing and verification
   user account management
   partner program integration
   environmental impact tracking.

The system's artificial intelligence capabilities extend throughout the operational chain, implementing:
a) real-time material identification through multi-spectral analysis with continuous accuracy improvement;
b) predictive analytics for maintenance scheduling and capacity optimization;
c) dynamic route optimization for logistics operations based on real-time data;
d) automated reward calculations incorporating material quality metrics and market conditions; and
e) continuous system optimization through machine learning algorithms processing operational data.

In various embodiments, the system's distributed ledger implementation provides:
a) immutable recording of all material deposits and transactions;
b) transparent tracking of reward distributions through smart contracts;
c) secure chain-of-custody verification with RFID integration;
d) automated reward distribution through blockchain protocols; and
e) decentralized data validation ensuring system integrity.

The system further includes a reward management system that offers users varied incentives through:
a) multiple reward distribution options including digital tokens, retail discounts, and charitable donations;
b) dynamic reward rate adjustment based on material type and quality;
c) partner program integration for enhanced user benefits;
d) automated reward distribution through blockchain smart contracts; and
e) transparent transaction recording and verification.

The following detailed description proceeds with reference to the accompanying drawings that form a part hereof, and in which are shown, by way of illustration, specific embodiments in which the disclosed subject matter may be practiced. The embodiments described herein support and clarify the claims, which define the scope of the invention.

### System Initialization and Calibration

The system implements a structured initialization sequence comprising:

### 1. Hardware Calibration:

Multi-spectral sensor alignment
Weight sensor zero-point calibration
Environmental sensor baseline establishment
Authentication system verification

### 2. Software Initialization:

Local AI model loading
Blockchain node synchronization
Security protocol activation
Communication channel establishment

### 3. Operational Verification:

Component self-test sequence
System integration verification
Performance benchmark execution
Safety system confirmation

### Measurement and Validation Protocols

The following measurement protocols are used to validate system performance:

### 1. Material Identification Accuracy:

Test methodology
Equipment specifications
Validation procedures
Error margin calculations

### 2. System Performance Metrics:

Testing conditions
Measurement methods
Performance thresholds
Quality control parameters

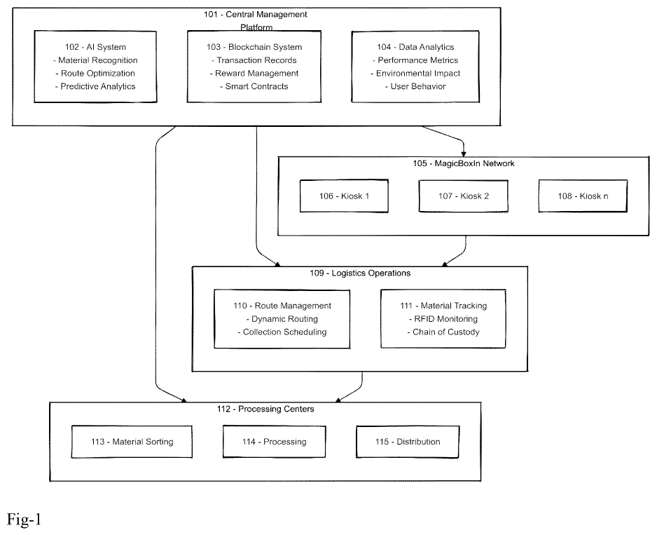

### FIG. 1: System Architecture and Component Integration

Referring specifically to FIG. 1, wherein is shown a block diagram illustrating the system architecture of the present invention, said architecture substantially comprises a central management platform (101), wherein said platform is operatively coupled to a MagicBoxIn network (105), logistics operations (109), and processing centers (112), and wherein said components are interconnected through secure wireless and wired communication channels.

The central management platform (101) of the present invention comprises:

An AI system (102), wherein said AI system is configured to:
perform material recognition operations;
perform route optimization protocols; and
implement predictive analytics;
   whereby said AI system substantially improves operational efficiency of the recycling ecosystem.

A blockchain system (103), wherein said blockchain system is adapted to:
maintain transaction records;
perform reward management; and
implement smart contracts;
   whereby said blockchain system ensures secure and transparent operation of the recycling ecosystem.

A data analytics module (104), wherein said module is configured to:
analyze performance metrics;
measure environmental impact; and
process user behavior patterns;
   whereby said analytics module enables continuous system optimization.

In accordance with another aspect of the present invention, the MagicBoxIn network (105) comprises a plurality of kiosks, wherein said plurality includes:
a first kiosk (106);
a second kiosk (107); and
an nth kiosk (108);
   wherein each of said kiosks is adapted to operate as an independent node while maintaining operative communication with said central management platform through encrypted wireless channels.

The logistics operations module (109) of the present invention comprises:

A route management system (110), wherein said system is configured to:
perform dynamic routing; and
implement collection scheduling;
   whereby said routing system substantially improves operational efficiency.

A material tracking system (111), wherein said system is adapted to:
perform RFID monitoring; and
maintain chain of custody;
   whereby said tracking system ensures complete material traceability.

In accordance with yet another aspect of the present invention, the processing centers (112) comprise:

A material sorting unit (113), wherein said unit is configured to:
perform initial material classification; and
implement automated segregation;
   whereby said sorting unit ensures proper material separation.

A processing unit (114), wherein said unit is adapted to:
perform processing operations; and
maintain quality standards;
   whereby said processing unit optimizes material recovery.

A distribution unit (115), wherein said unit is configured to:
perform material routing; and
implement logistics protocols;
   whereby said distribution unit ensures efficient material handling.

In accordance with a further aspect of the present invention, the system architecture maintains operative communication between all subsystems through secure wireless and wired communication channels, wherein said communication enables:
real-time data synchronization;
coordinated operations;
system-wide optimization;
continuous monitoring; and
automated response;
   whereby said architecture ensures continuous system operation through coordinated interaction between said subsystems.

The present invention thus provides an integrated recycling ecosystem wherein each component operates both independently and in coordination with other components through secure communication channels, thereby maintaining operational integrity through comprehensive monitoring and control protocols.

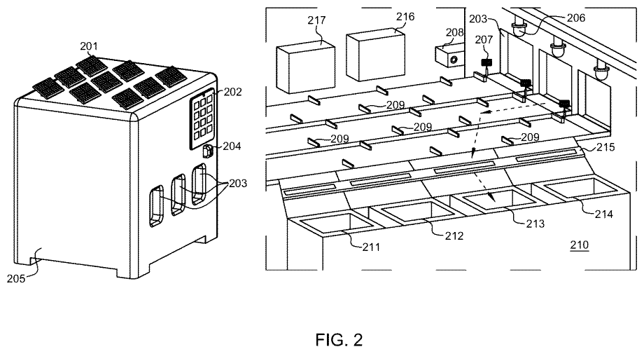

### FIG. 2: MagicBoxIn Kiosk Structure

Referring specifically to FIG. 2, a front elevation view and partial cutaway illustration shows a MagicBoxIn kiosk (200) comprising an external housing portion and an internal component assembly for automated material processing.

The external housing portion comprises:

A solar panel array (201) disposed on the upper surface, configured to:
generate operational power;
charge storage systems; and
maintain energy independence;
   ensuring continuous operation.

A user interface display (202) integrated into the front surface, configured to:
facilitate authentication;
enable reward selection;
provide guidance; and
display status;
   enabling user interaction.

A plurality of material input mechanisms (203) arranged vertically, configured to:
accept diverse materials;
prevent unauthorized access;
verify dimensions; and
enable sorted intake;
   ensuring secure handling.

A modular external housing (204) providing:
environmental protection;
maintenance access;
component integration; and
thermal management;
   ensuring system integrity.

A base unit (205) providing:
structural support;
battery housing;
level positioning; and
stable installation;
   ensuring operational stability.

The internal component assembly comprises:

A multi-spectral scanning array (206) positioned at the upper portion, providing:
material composition analysis;
contaminant detection;
dimensional measurement; and
data transmission to AI unit (207);
   enabling accurate identification.

An AI processing unit (207) positioned centrally, executing:
scan data analysis from array (206);
material classification;
sorting control; and
Process Optimization;
   enabling intelligent handling.

A sorting mechanism (208) adjacent to AI unit (207), performing:
routing execution;
material direction;
separation control; and
contamination prevention;
   ensuring precise distribution.

Material guidance channels (209) in parallel configuration, providing:
sorted material conveyance;
directed flow control;
material separation; and
optimal routing;
   enabling efficient distribution.

Storage compartments (210-214) arranged horizontally, providing:
sorted material collection;
capacity monitoring;
segregated storage; and
collection access;
   optimizing storage efficiency.

An RFID tracking system (215) integrated along storage array, executing:
movement monitoring;
inventory tracking;
capacity assessment; and
collection scheduling;
   ensuring material traceability.

An edge computing processor (216) in the upper portion, managing:
operational coordination;
AI system integration;
offline functionality; and
performance optimization;
   ensuring reliable operation.

A communication module (217) adjacent to processor (216), enabling:
network connectivity;
data synchronization;
remote monitoring; and
system updates;
   maintaining operational integration.

The system implements an integrated processing sequence wherein:

Data from scanning array (206) is analyzed by AI unit (207), which directs sorting mechanism (208) to route materials through guidance channels (209) into designated storage compartments (210-214), with continuous tracking by RFID system (215) and coordination by processor (216), while communication module (217) maintains secure network connectivity. This integration enables efficient, automated material processing from intake through storage.

The components operate in coordinated fashion to:
identify and sort materials;
maintain separation;
track inventory; and
optimize operations;
   creating a comprehensive recycling solution.

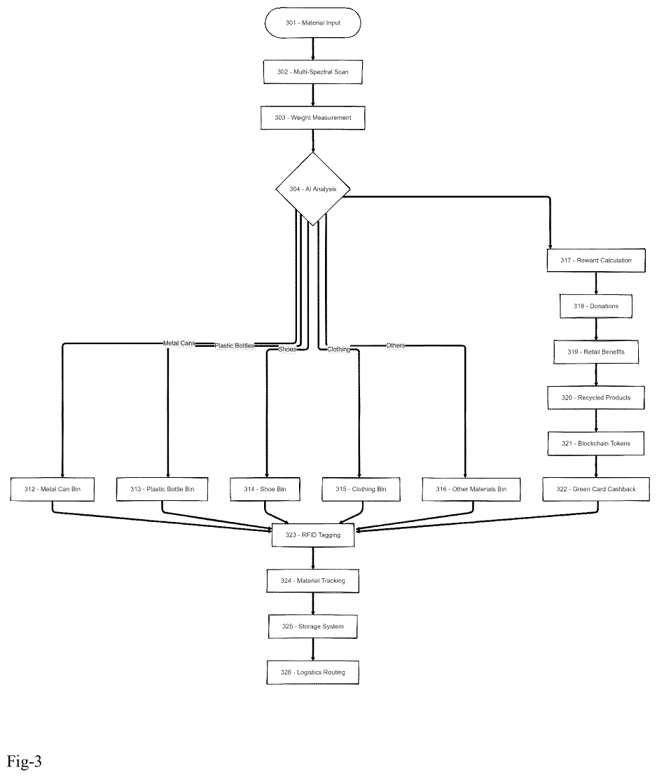

### FIG. 3: Material Processing and Reward Distribution Flow

Referring specifically to FIG. 3, a flowchart depicts the material processing and reward distribution sequence of the present invention, wherein said sequence comprises a primary material handling pathway and a parallel reward distribution pathway.

The primary material handling pathway initiates with:

A material input stage (301), wherein recyclable materials enter the system through secure input mechanisms;

A multi-spectral scan operation (302), providing:
material composition analysis;
contaminant detection;
dimensional verification; and
surface characteristic assessment;
   enabling precise material identification.

A weight measurement stage (303), executing:
mass determination;
density calculation;
load distribution analysis; and
capacity verification;
   ensuring accurate material quantification.

An AI analysis node (304), performing:
data integration from stages (302) and (303);
material classification;
sorting determination; and
routing optimization;
   directing materials to designated processing paths for:
metal cans;
plastic bottles;
shoes;
clothing; and
other materials;

The material sorting pathway terminates in designated receptacles:
metal can bin (312);
plastic bottle bin (313);
shoe bin (314);
clothing bin (315); and
other materials bin (316);
   enabling segregated material storage.

The parallel reward distribution pathway comprises:

A reward calculation module (317), determining:
material value assessment;
quality multipliers;
volume bonuses; and
market-based adjustments;
   establishing reward value.

A donation processing unit (318), enabling:
charitable contribution options;
tax receipt generation;
impact tracking; and
beneficiary selection;
   facilitating social impact.

A retail benefits processor (319), managing:
merchant partnerships;
discount generation;
reward point calculation; and
benefit distribution;
   enabling commercial incentives.

A recycled products module (320), offering:
sustainable merchandise;
material credit application;
product selection; and
fulfillment processing;
   promoting circular economy.

A blockchain token generator (321), executing:
digital asset creation;
smart contract deployment;
wallet integration; and
transaction recording;
   ensuring secure value transfer.

A green card cashback processor (322), managing:
reward accumulation;
benefit calculation;
partner integration; and
disbursement processing;
   enabling financial incentives.

The system implements unified tracking through:

An RFID tagging module (323), providing:
unique identifier assignment;
material association;
location tracking; and
chain-of-custody maintenance;
   ensuring material traceability.

A material tracking system (324), executing:
location monitoring;
movement verification;
status updates; and
inventory management;
   maintaining operational control.

A storage system (325), managing:
capacity optimization;
environmental control;
access regulation; and
maintenance scheduling;
   ensuring material preservation.

A logistics routing module (326), coordinating:
collection scheduling;
route optimization;
resource allocation; and
delivery planning;
   enabling efficient material transport.

The flowchart illustrates operational integration wherein:

Material input (301) progresses through analysis stages (302-304), directing materials to appropriate bins (312-316), while parallel reward processing (317-322) enables multiple incentive options, with unified tracking (323-326) ensuring system-wide control and optimization.

This integrated approach enables:
accurate material processing;
diverse reward distribution;
comprehensive tracking; and
optimized logistics;
   creating an efficient and engaging recycling ecosystem.

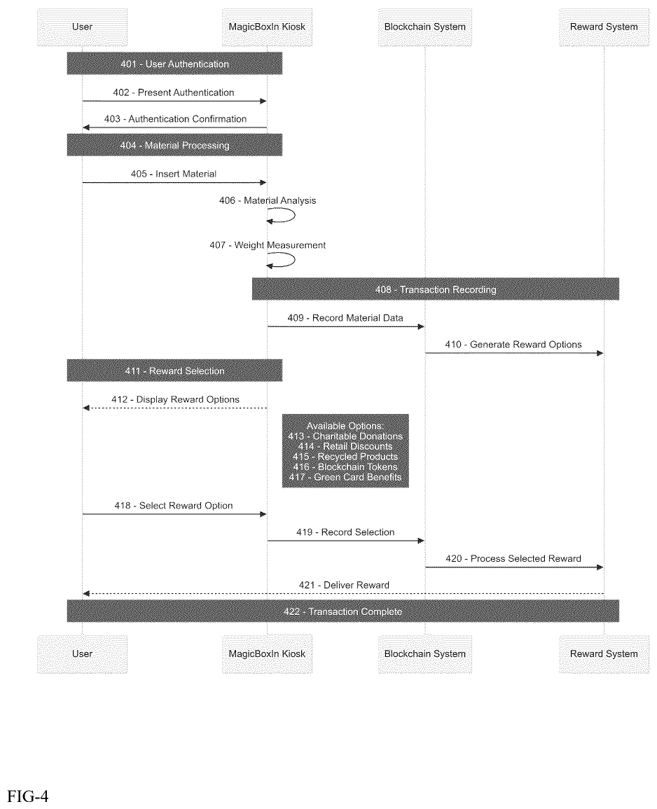

### FIG. 4: User Interaction Process

Referring specifically to FIG. 4, a sequence diagram illustrates the interaction flow between four primary system components: User, MagicBoxIn Kiosk, Blockchain System, and Reward System, wherein said interaction comprises authentication, material processing, and reward distribution phases.

The authentication phase initiates with:

A user authentication sequence (401), wherein said sequence comprises:
presentation of authentication credentials (402) from User to MagicBoxIn Kiosk;
verification of provided credentials; and
authentication confirmation (403) returned to User;
   establishing secure system access.

The material processing phase comprises:

A material processing sequence (404), wherein:
User initiates material insertion (405);
MagicBoxIn Kiosk performs material analysis (406) through:
   multi-spectral scanning;
   composition verification;
   contaminant detection; and
   quality assessment;
System executes weight measurement (407) including:
   mass determination;
   density calculation; and
   volume verification;
      ensuring accurate material assessment.

The transaction recording phase comprises:

A transaction recording sequence (408), wherein:
MagicBoxIn Kiosk records material data (409) to Blockchain System;
Blockchain System generates reward options (410) based on:
   material type;
   quality metrics;
   quantity processed; and
   market conditions;
      maintaining transaction integrity.

The reward selection phase comprises:

A reward selection sequence (411), wherein:
System displays available reward options (412) including:
   charitable donations (413);
   retail discounts (414);
   recycled products (415);
   blockchain tokens (416); and
   green card benefits (417);
      enabling user choice.

The reward processing sequence continues with:

User reward selection (418), wherein:
User selects preferred reward option;
System records selection (419) in Blockchain System;
Reward System processes selected reward (420);
System delivers reward to User (421);
   completing reward distribution.

The transaction completion phase (422) comprises:
confirmation across all system components;
synchronization of:
   User account status;
   MagicBoxIn Kiosk inventory;
   Blockchain records; and
   Reward System balances;
      ensuring transaction finality.

The sequence diagram demonstrates system integration wherein:

User interaction flows through:
authentication (401-403);
material processing (404-407);
transaction recording (408-410);
reward selection (411-418);
reward processing (419-421); and
transaction completion (422);
   maintaining operational coherence.

Communication paths comprise:
direct user interactions with kiosk;
kiosk communication with blockchain;
blockchain integration with rewards; and
system-wide synchronization;
   ensuring secure data flow.

The system implements verification at:
initial authentication;
material processing;
transaction recording;
reward selection; and
completion confirmation;
   maintaining process integrity.

This sequential approach enables:
secure user interaction;
accurate material processing;
verified transaction recording;
flexible reward distribution; and
system-wide synchronization;
   creating a comprehensive recycling transaction ecosystem.

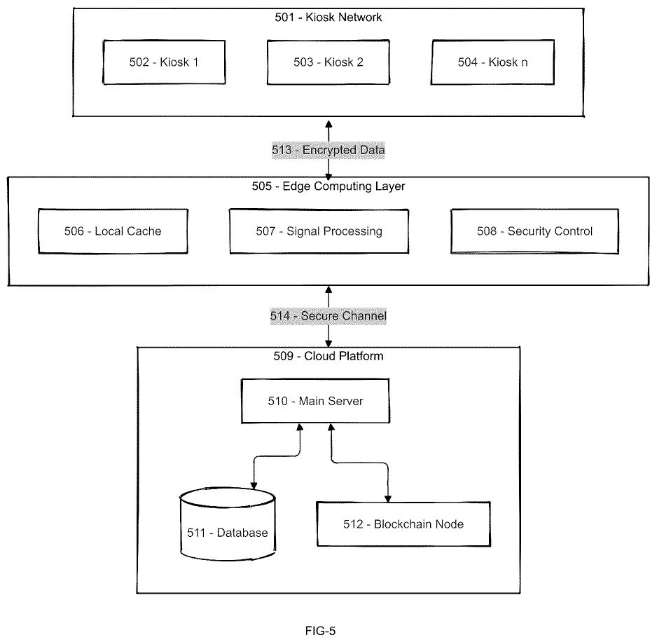

### FIG. 5: Network and Security Architecture

Referring specifically to FIG. 5, a schematic diagram illustrates the hierarchical network and security architecture of the system, comprising three primary layers: kiosk network, edge computing, and cloud platform infrastructure.

The kiosk network layer (501) comprises:

A distributed network of kiosks including:
first kiosk unit (502);
second kiosk unit (503); and
nth kiosk unit (504);
   enabling scalable deployment.

Each kiosk maintains:
independent operational capability;
local processing functions;
secure data collection; and
network communication;
   ensuring continuous operation.

The edge computing layer (505) comprises:

A local cache system (506) providing:
temporary data storage;
offline operation support;
rapid access retrieval; and
synchronization management;
   ensuring operational continuity.

A signal processing unit (507) executing:
data normalization;
preliminary analysis;
protocol conversion; and
transmission optimization;
   enabling efficient data handling.

A security control module (508) implementing:
access verification;
threat detection;
encryption management; and
protocol enforcement;
   maintaining system security.

The cloud platform (509) comprises:

A main server (510) providing:
centralized processing;
system coordination;
service management; and
resource allocation;
   enabling system administration.

A database system (511) managing:
operational data;
user information;
transaction records; and
system metrics;
   ensuring data persistence.

A blockchain node (512) executing:
transaction validation;
smart contract operations;
distributed consensus; and
ledger maintenance;
   ensuring immutable record-keeping.

The system implements secure communication through:

Encrypted data channels (513) providing:
end-to-end encryption;
data integrity verification;
secure packet transmission; and
protocol compliance;
   ensuring data protection.

Secure communication channels (514) maintaining:
authenticated connections;
encrypted data flow;
channel monitoring; and
intrusion prevention;
   enabling protected data exchange.

The architecture enables hierarchical data flow wherein:
kiosk network (501) generates operational data;
edge computing layer (505) processes and secures data;
encrypted channels (513, 514) ensure secure transmission; and
cloud platform (509) manages centralized operations;
   creating a comprehensive processing infrastructure.

System integration provides:
distributed processing capability;
secure data management;
scalable operations; and
reliable service delivery;
   establishing a robust operational framework.

The layered approach enables:
local operational autonomy;
efficient data processing;
secure communication; and
centralized management;
   maintaining system reliability and security.

Each layer implements redundancy through:
parallel processing paths;
backup systems;
failover protocols; and
data replication;
   ensuring continuous operation.

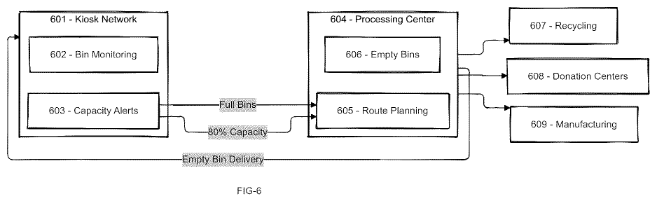

### FIG. 6: Processing Center Operations and Logistics Workflow

Referring specifically to FIG. 6, a flowchart illustrates the integrated logistics and operations workflow between kiosk network and processing center components, wherein said workflow enables continuous material handling and distribution management.

The kiosk network component (601) comprises:

A bin monitoring system (602) providing integrated operations management through:
continuous real-time capacity tracking;
automated material level assessment;
comprehensive status monitoring; and
systematic health verification;
   whereby said system maintains continuous operational awareness across the network.

A capacity alert system (603) executing configurable threshold management through:
programmable threshold monitoring with:
   configurable full-capacity parameters;
   adjustable warning levels at 80% capacity; and
   customizable maintenance triggers;
      whereby said system enables proactive intervention and resource allocation.

The processing center component (604) comprises:

A route planning module (605) implementing dynamic logistics management through:
automated collection scheduling based on:
   real-time bin status data;
   network-wide capacity levels; and
   resource optimization algorithms;
      whereby said module ensures efficient material collection and transport.

An empty bin management system (606) coordinating operational readiness through:
systematic bin inventory control;
standardized sanitization protocols;
scheduled maintenance procedures; and
strategic deployment coordination;
   whereby said system maintains continuous operational capability.

The distribution pathway comprises three primary channels:

A recycling facility interface (607) executing material recovery through:
automated sorting operations;
systematic quality verification;
coordinated processing scheduling; and
optimized material reclamation;
   whereby said interface maximizes resource recovery.

A donation center connection (608) managing reusable items through:
systematic item classification;
coordinated distribution protocols;
automated impact assessment; and
integrated beneficiary management;
   whereby said connection optimizes social benefit delivery.

A manufacturing integration (609) enabling material transformation through:
standardized raw material processing;
automated quality control;
integrated supply chain management; and
circular economy facilitation;
   whereby said integration promotes sustainable material utilization.

The system implements three interconnected operational cycles:

### 1. Continuous Monitoring Cycle:

The bin monitoring system (602) maintains constant surveillance of network status, triggering capacity alerts (603) at predetermined thresholds, thereby initiating route planning (605) for optimal collection scheduling.

### 2. Material Processing Cycle:

Upon alert activation, the route planning module (605) coordinates with empty bin management (606) to execute efficient collection and replacement operations, directing materials through appropriate distribution channels (607-609) based on material classification and optimal utilization paths.

### 3. Bin Circulation Cycle:

The processing center (604) maintains continuous bin flow through:
systematic empty bin preparation;
strategic deployment to network locations;
immediate monitoring initiation upon placement; and
continuous cycle repetition;
   whereby said cycle ensures uninterrupted system operation.

The integrated workflow architecture enables:
predictive operational management;
optimized resource utilization.
efficient material distribution; and
automated system adaptation.
   establishing a comprehensive logistics ecosystem.

This systematic approach creates a self-sustaining operational framework wherein continuous monitoring drives proactive management, enabling efficient material handling while maintaining optimal system performance through automated threshold management and coordinated distribution operations.

The present invention thus provides an integrated logistics solution that optimizes material handling efficiency while maximizing environmental and social impact through coordinated collection, processing, and distribution operations.

1. A smart recycling system for automated material processing and distribution, comprising:
a) a network of automated recycling kiosks operatively connected through secure communication channels, wherein each kiosk comprises:
a solar-powered energy system comprising:
photovoltaic arrays generating minimum 2 kW power
battery backup system with 24-hour capacity
power management unit maintaining 85%±2% energy conversion efficiency
automated switchover circuits for grid power integration;
a secure authentication interface implementing at least three-factor authentication comprising:
biometric scanner with 1000 dpi minimum resolution
RFID reader operating at 13.56 MHz with −60dBm sensitivity
encrypted PIN verification module
mobile device NFC detector operating at 13.56 MHz
secure data transmission protocols with AES-256 encryption;
a multi-spectral scanning system comprising:
visible spectrum sensors (400-700 nm)
near-infrared sensors (701-2500 nm)
calibrated light sources
optical filtering arrays
achieving minimum 95% material identification accuracy through spectral signature matching; wherein said spectral signature matching comprises comparing measured spectral data against a reference database containing at least 1,000 known material signatures and generating confidence metrics including a combined weighted average having a minimum 95% threshold for acceptance;
an artificial intelligence processing unit comprising:
edge computing processors achieving 4 TOPS minimum
local cache memory of 8 GB minimum
hardware-accelerated neural networks
sub-second classification latency
real-time model optimization capabilities; wherein said real-time model optimization capabilities include federated learning in which local models train on kiosk-specific data and transmit model parameter updates to a central server without raw data transfer;
a plurality of modular storage bins comprising:
UHF RFID tags operating at 860-960 MHz
capacitive sensors with 98%±0.5% fill-level accuracy
automated bin rotation mechanisms
environmental monitoring sensors
mechanical load distribution systems;
a secure material input mechanism comprising:
motorized intake conveyor system
multi-sensor contamination detection array
mechanical rejection mechanisms
automated sorting gates
material flow control systems; wherein the mechanical rejection mechanisms are configured to automatically reject or divert a deposited item when the combined weighted average is below said minimum 95% threshold for acceptance or when the item is classified as a prohibited material;
an interactive reward distribution interface comprising:
real-time market value processors
secure transaction modules
multi-currency support
automated smart contract execution
user feedback display systems; wherein the real-time market value processors update dynamic market values at intervals of 5 minutes or less and apply sustainability multipliers;
b) a central management platform comprising:
an artificial intelligence system comprising:
deep learning neural networks
distributed training architecture
continuous model updating mechanisms
performance optimization algorithms
real-time adaptation capabilities;
a dynamic route optimization module comprising:
real-time traffic data processors
predictive analytics engines
route calculation accelerators
fleet management systems
resource allocation optimizers; and a capacity alert system executing adjustable warning levels at configurable capacity thresholds and initiating collection scheduling and bin replacement operations via an integrated empty bin management system;
a blockchain transaction system comprising:
Proof-of-Stake consensus mechanisms
smart contract execution engines
distributed ledger nodes
transaction validation processors
automated settlement systems; wherein transaction validation requires consensus confirmation from at least 51% of participating validator nodes with a confirmation time of 2 seconds or less, and wherein an immutable transaction record includes (i) a material identification result and (ii) at least one confidence metric;
a customizable reward management system comprising:
automated value adjustment algorithms
market data integration processors
user preference engines
dynamic pricing modules
reward distribution mechanisms;
c) a processing center comprising:
automated material sorting systems achieving 98%±0.5% accuracy
real-time inventory management processors
quality control mechanisms
material flow optimization systems
automated distribution controllers.

2. The system of claim 1, wherein the reward distribution interface enables users to select from:
blockchain-based tokens with ERC-20 smart contract implementation;
retail discounts with real-time validation through API integration;
donation credits with automated tax receipt generation;
recycled products with digital tracking certificates; and
enhanced green card cashback with instant settlement processing.

3. The system of claim 1, wherein each storage bin comprises:
real-time capacity monitoring with ultrasonic sensors operating at 40 kHz;
automated RFID tracking with −90 dBm sensitivity;
predictive maintenance alerts based on IoT sensor data;
environmental sensors monitoring temperature (−20° C. to 70° C.) and humidity (0-100%); and
secure access protocols using AES-256 encryption.

4. The system of claim 1, wherein the route optimization module:
monitors bin capacity with 1-minute update intervals;
generates alerts at user-configurable thresholds (50-95%);
optimizes routes using machine learning with 15-minute traffic updates;
schedules maintenance based on predictive modeling with 95% accuracy.

5. The system of claim 1, wherein the artificial intelligence processing unit is configured to:
perform real-time material quality assessment with 98% accuracy within 100 ms;
detect contamination using multi-spectrum analysis (UV-VIS range);
identify reusable items with 95% classification accuracy;
adapt sorting criteria using reinforcement learning algorithms;
optimize classification through federated learning with 1% accuracy improvement per week.

6. The system of claim 1, wherein the processing center comprises:
automated material segregation systems with 99% sorting accuracy;
quality control checkpoints with computer vision verification;
distribution routing optimized for 95% logistics efficiency;
real-time tracking with 99.9% chain-of-custody accuracy;
predictive maintenance with 48-hour advance alerts;
RFID-enabled inventory management with 99.9% accuracy.

7. The system of claim 1, wherein the blockchain transaction system:
records deposits with SHA-256 encryption;
processes transactions within 2-second confirmation time;
maintains immutable history with distributed consensus;
enables token transfers with smart contract automation;
provides audit trails with 7-year data retention.

8. The system of claim 1, wherein the central management platform includes:
real-time monitoring dashboards;
predictive maintenance scheduling;
automatic software updates;
system health monitoring; and
performance analytics reporting.

9. The system of claim 1, wherein the reward management system includes:
dynamic reward rate adjustment based on:
material market values;
seasonal variations;
local recycling demands;
multi-tier partnership integration; and
automated reward distribution.

10. A method for automated material identification and reward distribution in a recycling system, comprising:
authenticating a user through a multi-factor verification process comprising:
capturing biometric data using a 1000 dpi resolution scanner
reading RFID credentials using a 13.56 MHz scanner with −60 dBm sensitivity
validating encrypted PIN input through a secure keypad
verifying mobile device signatures using NFC protocols
executing authentication confirmation through hardware security modules;
receiving recyclable materials through an automated input mechanism comprising:
activating motorized intake conveyor systems
measuring material weight using load cells with ±0.1% accuracy
scanning three-dimensional dimensions using laser measurement systems
detecting material composition through capacitive sensors
verifying material compliance using multi-sensor arrays;
performing real-time material analysis comprising:
activating calibrated light sources across visible spectrum (400-700 nm)
measuring near-infrared reflectance (701-2500 nm)
processing spectral data through dedicated signal processors
comparing spectral signatures against material database
generating material composition profiles with confidence metrics; wherein comparing spectral signatures comprises comparing measured spectral data against a reference database containing at least 1,000 known material signatures and computing a combined weighted average having a minimum 95% threshold for acceptance;
classifying materials using an artificial intelligence system comprising:
executing neural network models on dedicated hardware processors
performing real-time inference with sub-second latency
achieving minimum 95% classification accuracy
updating model parameters through federated learning
generating classification confidence scores; wherein said federated learning updates occur without raw data transfer by transmitting only model parameter updates to a central server;
automatically sorting materials comprising:
activating servo-controlled sorting mechanisms
controlling pneumatic separation systems
operating mechanical sorting gates
monitoring sorting accuracy through sensor arrays
verifying material placement in designated bins; further comprising automatically rejecting or diverting an item when the combined weighted average is below said minimum 95% threshold or when the item is classified as a prohibited material;
tracking materials using UHF RFID system comprising:
broadcasting UHF signals at 860-960 MHz
achieving 99.9%±0.05% read accuracy
monitoring material movement through multiple checkpoints
recording spatial location data
maintaining chain-of-custody verification;
recording transactions comprising:
initiating blockchain smart contracts
executing proof-of-stake consensus protocols
validating transaction blocks
maintaining distributed ledger integrity
generating immutable transaction records; wherein validating transaction blocks requires consensus confirmation from at least 51% of participating validator nodes with a confirmation time of 2 seconds or less, and wherein the immutable transaction records include a material identification result and at least one confidence metric;
calculating personalized rewards comprising:
processing real-time market data
executing value optimization algorithms
applying quality multipliers based on material analysis
calculating environmental impact credits
generating reward distribution options; wherein real-time market data includes dynamic market values updated at intervals of 5 minutes or less and sustainability multipliers;
enabling reward distribution comprising:
activating secure API endpoints
processing user selection inputs
executing smart contract distributions
generating digital reward tokens
confirming transaction completion through blockchain validation.

11. The method of claim 10, wherein calculating personalized rewards comprises:
analyzing materials using multi-parameter classification (>10 attributes);
applying market rates updated at 5-minute intervals;
implementing sustainability multipliers (1.1-2.0×);
tracking user history with blockchain verification;
adjusting rewards using dynamic pricing algorithms.

12. The method of claim 10, further comprising:
monitoring capacity with 1-minute update frequency;
analyzing patterns using time-series prediction (95% accuracy);
optimizing routes with real-time traffic integration;
scheduling maintenance using IoT sensor data;
updating system status within 100 ms latency.

13. The method of claim 10, wherein user authentication comprises:
biometric verification;
mobile application integration;
loyalty card recognition;
digital wallet association; and
social media account linking.

14. The method of claim 10, further comprising user engagement features:
providing real-time environmental impact metrics including:
carbon footprint reduction calculations;
landfill diversion measurements;
recycling efficiency scores;
community impact statistics;
generating social media sharing options;
offering gamification elements;
enabling community challenge participation; and
providing personalized recycling insights.

15. A smart recycling kiosk for automated material processing, comprising:
an integrated power management system comprising:
photovoltaic arrays generating minimum 2 kW capacity
lithium-ion battery array providing 24-hour backup power
voltage regulation circuits maintaining ±1% stability
automated power switching mechanisms
grid power integration with phase synchronization
real-time power monitoring sensors;
a multi-modal authentication interface comprising:
biometric scanner with 1000 dpi minimum resolution
RFID reader operating at 13.56 MHz with −60 dBm sensitivity
encrypted PIN pad with tamper detection
NFC detector for mobile device authentication
QR code scanner with 1280×960 resolution
secure element storage for credential processing
hardware security module for encryption;
an advanced multi-spectral scanning array comprising:
visible light sensors (400-700 nm wavelength)
near-infrared sensors (701-2500 nm wavelength)
calibrated light source arrays
beam splitters and optical filters
temperature-stabilized detector arrays
automated calibration mechanisms
real-time spectral data processors; wherein the advanced multi-spectral scanning array performs spectral signature matching against a reference database containing at least 1,000 known material signatures and produces confidence metrics including a combined weighted average having a minimum 95% threshold for acceptance;
a local artificial intelligence system comprising:
dedicated neural processing units delivering minimum 4 TOPS
8GB minimum high-speed cache memory
hardware-accelerated inference engines
real-time model optimization processors
edge computing modules with failover capability
thermal management systems
dedicated signal processing arrays; wherein the local artificial intelligence system updates algorithms using federated learning without raw data transfer;
environmentally-controlled modular storage bins;
a user interface system comprising:
high-brightness touch display
vandal-resistant input devices
multi-language support processors
emergency alert mechanisms
visual guidance systems
audio feedback generators
accessibility compliance features;
a secure material handling mechanism comprising:
motorized intake conveyor
multi-sensor contamination detection
mechanical rejection assembly
automated sorting gates
material flow controllers; wherein the mechanical rejection assembly is configured to automatically reject or divert an item when the combined weighted average is below said minimum 95% threshold or when the item is classified as a prohibited material;
a secure communication module configured to maintain encrypted connections with a central management platform.

16. The kiosk of claim 15, wherein the local AI processing unit:
operates with 99.9% uptime in offline mode;
synchronizes data every 30 seconds when connected;
updates algorithms using federated learning;
processes data at minimum 100 transactions per second;
maintains N+1 redundancy for critical functions.

17. The kiosk of claim 15, wherein the multi-spectral scanning system identifies:
metal and plastic containers;
textile materials including clothing and footwear;
electronic devices;
paper products;
glass items; and
prohibited materials.

18. The kiosk of claim 15, wherein security features comprise:
end-to-end data encryption;
biometric authentication options;
continuous system monitoring;
automated threat detection;
emergency protocols; and
secure maintenance access.

19. The kiosk of claim 15, further comprising modular design features enabling:
capacity expansion;
bin configuration modification;
sensor system upgrades;
power system enhancements; and
interface customization.

20. The kiosk of claim 15, wherein material sorting comprises:
separating reusable from non-reusable items;
categorizing by material type and condition;
identifying high-value materials;
detecting hazardous materials; and
optimizing storage allocation.
